(19) United States
(12) Patent Application Publication
(10) Pub. No.: US 2025/0162488 A1
(43) Pub. Date: May 22, 2025

(54) Transportable Tool Rack

(71) Applicant: Patrick Ryan Wise, Somerset, VA (US)

(72) Inventor: Patrick Ryan Wise, Somerset, VA (US)

(21) Appl. No.: 18/831,301

(22) Filed: Oct. 22, 2024

Related U.S. Application Data
(60) Provisional application No. 63/629,757, filed on Nov. 22, 2023.

(51) Int. Cl. B60P 7/08; B25H 5/00; B60P 3/06; B62B 3/00; B62B 3/02; B62B 3/10; B62B 5/00

(52) U.S. Cl. CPC B60P 7/0815; B25H 5/00; B60P 3/06; B62B 3/002; B62B 3/02; B62B 3/10; B62B 5/0033; B62B 2202/48

(57) ABSTRACT

A portable device for transporting tools and materials from a flat surface of a vehicle to a location near a job site. The device is comprised of a tool rack that contains the tools and a base with transporting wheels. The tool rack is releasably and slidingly attached to a base by way of an interlocking rail mechanism that does not restrict access to the tools.

### CROSS REFERENCE TO RELATED APPLICATIONS:

This patent application makes reference to and thereby incorporates all information found in the provisional patent application numbered: 63629757 entitled Transportable Tool Rack filed 22 Nov. 2023 by Patrick Ryan Wise.

### BACKGROUND OF THE INVENTION:

Deployment of tools and equipment is an important part of work projects. Often contractors that perform jobs transport tools and equipment to a job site. Job sites are sometimes such that tools and equipment are moved from location to location for work to progress efficiently. Often tools and equipment are too great in number, too large, and/or too heavy to be carried by a person wearing a work belt or the like. Those performing work in which tools and equipment are utilized can benefit from a portable carriage that holds and stores such tools and equipment for transport to and from a job site as well as between locations on a job site. For example, the tools and equipment can be selected for electrical work, mechanical work, and/or electronic work, etc. For example, tools and supplies can comprise power tools, bits for power tools, fasteners, screwdrivers, pliers, wire cutters, wire strippers, knives, hammers, wire connectors, lighting fixtures, conduit, conduit fittings, pipes, pipe fittings, duct, screws, bolts, nuts, nails, etc. For example, different containment units containing different tools and equipment needed for a wide array of work can be rotated in and out of use on an as needed basis saving time from loading and unloading tools and equipment. What is needed is a tool rack that is easily transportable to a location near the work site such that access to tools and equipment is quicker, more efficient, and convenient to the worker.

### SUMMARY

The tool transporting device of the present invention can be easily transported from a vehicle to a location at the work site that is close to where the work is to be done. The tool transporting device is comprised of a tool rack and a base to which the tool rack is slidingly and releasably attached. Certain exemplary embodiments utilize a containment unit or tool rack which is lockingly and releasably coupled to a collapsible gurney base via containment unit-base interlocking attachment mechanism or rail lock that locks two sets of rails together to prevent relative movement.

Base rails are permanently attached to the base and rack rails are permanently attached to the tool rack. The rack rails are configured to interlock with the base rails to form interlocking rails that allow for ease of sliding movement of the rack rail relative to the base rail but prevent inadvertent vertical or side movement of the tool rack relative to the base. The tool rack can be slidingly positioned onto the base and locked onto the base via rail lock to prevent any relative sliding movement between the tool rack and the base. The legs of the base have wheels that are power assisted by an electric motor and controlled by a variable speed controller at the operator's end of the gurney that provides ease of transport to a nearby work location, but the legs, wheels, and electric motor collapse away to allow the base to be collapsibly positioned into a motorized vehicle for transport away from the work site. Exemplary vehicles can comprise a van, truck, or station wagon. The advantages of the rail lock as opposed to straps or belts is the rail lock is stronger and does not restrict entry of tools into and out of the tool rack. The rail lock allows for the tool rack to be releasably detached and offloaded as well as attached and loaded with contents by sliding the containment unit onto the base and lockingly engaging the rail lock. The containment unit and the base along with tools and equipment can be transported and collapsed into a motorized vehicle like a van, truck, or station wagon and locked into place with the cargo receiving rail that is permanently attached to the cargo area of the motorized vehicle. The base and the tool rack can then be transported by the vehicle to a location proximate to a job site.

Once transported by motorized vehicle the base coupled with the tool rack can be unlocked from the cargo receiving rail and slid out of the vehicle via delivery wheels and expand from a delivery configuration to a transporting configuration. As the containment unit and the base are slid out of the vehicle, the legs of the base are extended such that the containment unit and the base can be rolled manually or with electric motor power assist to a desired location via transporting wheels where work is taking place. The tool rack can also be slid off of the base and rolled onto a work surface near the work site via tool rack wheels. Brake mechanisms are located on the transporting wheels, the delivery wheels, and the tool rack wheels to prevent unwanted rolling when the tool rack or base are intended to be stationary. Tools and equipment need to be picked up individually to be removed from the base and the rail lock allows for tools and equipment on the base to be offloaded slidingly from the base.

### BRIEF DESCRIPTION OF THE DRAWINGS

FIG. 1A Planar view of end section of base, rail lock, and tool rack.

FIG. 1B Planar view of side of base and containment unit tool rack on a vehicle with a flat surface.

FIG. 2 Planar side view of the tool rack and base on a flat surface of a vehicle.

FIG. 3A Planar view of tool rack and base adjacent to a work table near the work site.

FIG. 3B Planar view of tool rack and collapsed configuration located on a work table near the work site.

FIG. 4 Planar view of end section of base, rail lock, and tool rack in delivery configuration releasably attached to cargo receiving rail.

FIG. 5A Planar view of the end section of cargo receiving rail at the back end of a motorized vehicle.

FIG. 5B Side view of base, rail lock, and tool rack in delivery configuration releasably attached to cargo receiving rail in motorized vehicle.

FIG. 5C Side view of base, rail lock, and tool rack in transporting configuration detached from cargo receiving rail outside of motorized vehicle.

FIG. 5D Side view of base in transporting configuration and electric motor driver assist apparatus.

FIG. 5E Planar view of electric motor, variable speed controller cable, delivery wheels, and delivery wheel axle.

### DETAILED DESCRIPTION:

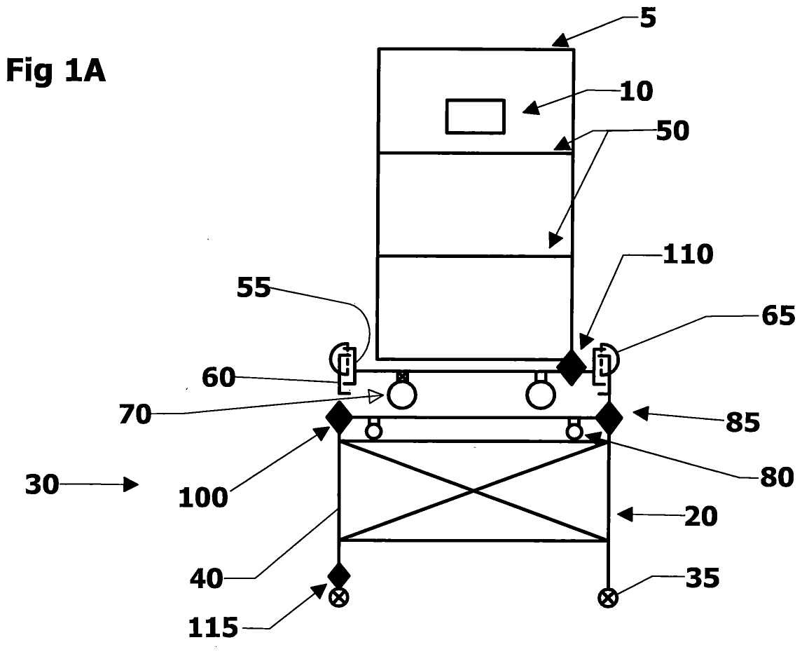

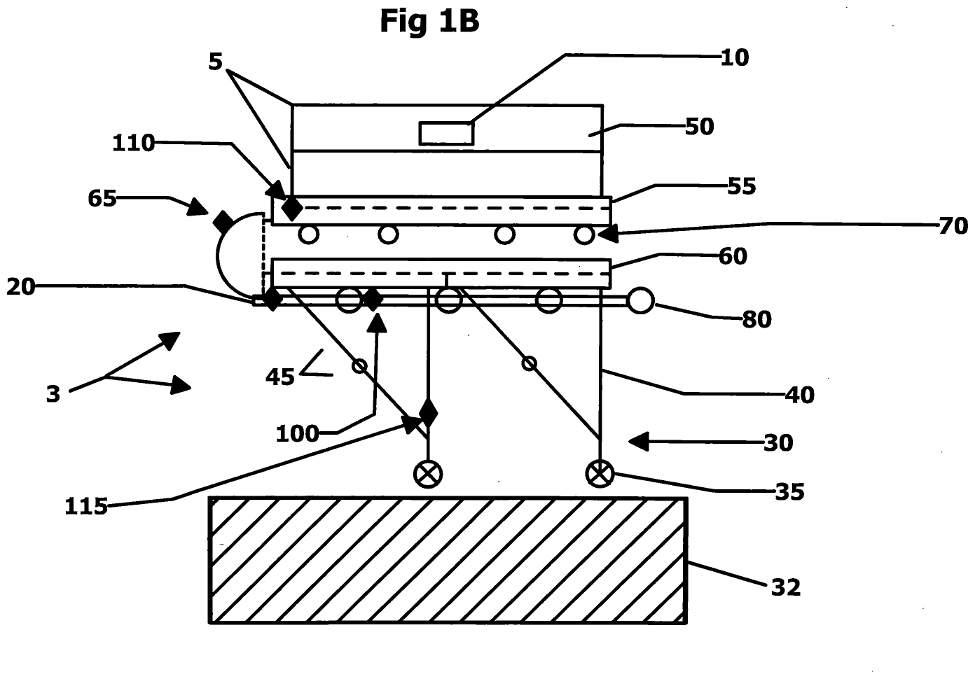

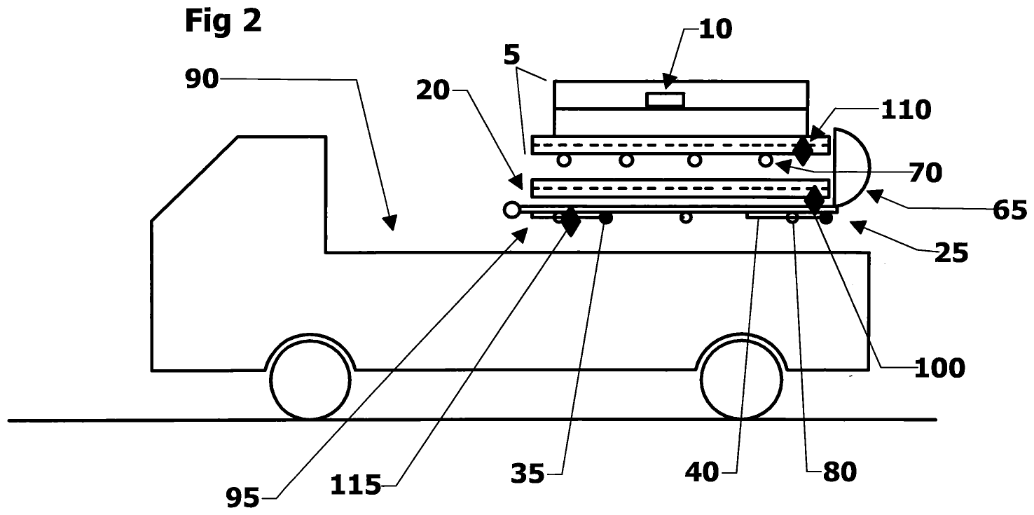

FIGS. 1A, 1B, and 2 show the tool transporting device 3 of the present invention comprising a transportable tool rack 5 and a base 20. The tool rack 5 contains tools and equipment 10 used by a home builder, a repair person, an electrician, a plumber, or other worker that is transported from a vehicle such as a motorized flat-bed truck or cargo vehicle 15 to a location at a work site that is closer than where the vehicle can be located. The tool rack 5 and base 20 can be rolled off of a flat-bed truck 15 with the base 5 from a collapsed configuration 25 (shown in FIG. 2), for example, and placed into a transporting configuration 30 as shown in FIGS. 1A and 1B and rolled on the ground or a flat surface 32 using transporting wheels 35 located on the collapsible legs 40 of the base 20 to a more convenient location close to the work site such that the worker can easily and quickly select an appropriate tool from the tool rack 5 to do the job. With the base in a transporting configuration 30 as shown in FIG. 1B, the collapsible legs 40 are in the supported linear configuration to extend the collapsible legs 40 downward to allow for stable rolling of the base 20 and tool rack 5 on the ground 32 via the transporting wheels 35. The tools and equipment 10 are located on sliding shelves 50 that provide direct access to individual tools and equipment 10 found in the tool rack 5. The sliding shelves 50 are able to be easily accessed by the worker even with the tool rack attached to the base since the base rails 60 and rail lock 65 are necessarily located below the tool rack such that the sliding shelves 50 are able to open and close freely.

The tool rack 5 or containment unit is positioned above a collapsible base 20 and is able to slide relative to the base 20 and off of the base 20 via a rack rail 55 that interlocks with a base rail 60. The rack rail 55 is permanently attached to the bottom of the tool rack 5 and slides relative to the base rail 60 that is permanently attached near the top of the base 20. The interlocking rack rail 55 and base rail 60 prevent movement of the tool rack 5 relative to the base 20 in a vertical direction or in a side or lateral direction. Locating the interlocking rail entirely at or near the bottom of the tool rack 5 is required for the present invention to provide free access without any restriction to the tools located in the tool rack 5 when the tool rack is attached to the base. A rail lock 65, such as a removable pin or other mechanical mechanism, for example, attaches the rack rail 55 to the base rail 60 to prevent sliding movement during transportation of the tool rack 5 in a motorized flat-bed truck or cargo vehicle 15 or during delivery of the tool rack 5 to the work site in the transporting configuration 30.

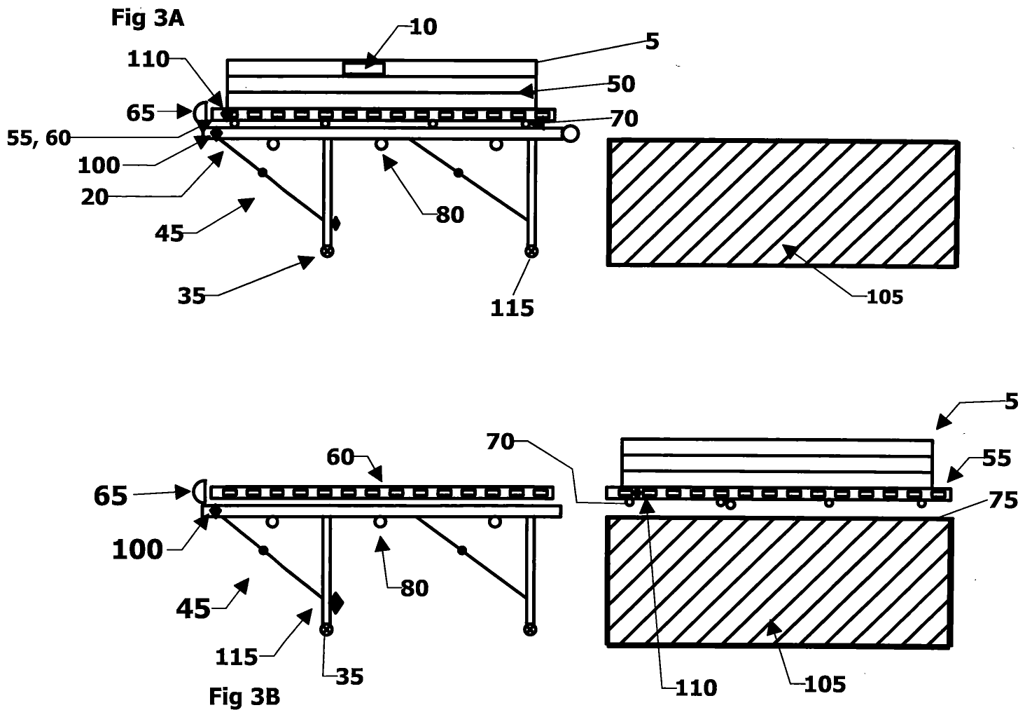

With the rail lock 65 removed the tool rack 5 is able to slide relative to the base 20 via tool rack wheels 70 that are mounted on the bottom surface of the tool rack 5. Such tool rack wheels 70 allow the tool rack 5 to be easily rolled onto a work surface 75 as will be described later in FIG. 3B. Delivery wheels 80 located on the bottom of the base surface 85 allow the base 20 and collapsible legs 40 together to be rolled onto a flat surface 90 such as that found in a flat-bed truck or a cargo vehicle 15, for example, with the rail lock 65 engaged to lock the rack rail 55 to the base rail 60.

FIG. 2 shows the tool rack 5 mounted to the base 20 with the rail lock 65 engaged for delivery on a flat delivery surface 90 of a motorized flat-bed or cargo vehicle 15. In this delivery configuration 95 the rail lock 65 maintains the attachment of the tool rack 5 to the base 20 during delivery and transport. The collapsible legs 40 of the base 20 are collapsed and the delivery wheels 80 of the base 20 are the primary mode of positioning on the flat delivery surface 90. In this delivery configuration 95 a base delivery braking mechanism 100 (such as a friction generating element that makes contact with a delivery wheel to prevent a delivery wheel from turning) of the base 20 is engaged to lock the delivery wheels 80 of the base 20 or secure the base 20 to the flat delivery surface 90, and the tool rack 5 and base 20 are maintained stationary and secure for delivery on a flat delivery surface 15.

FIGS. 2, 3A, 3B show the transporting of the tool rack 5 and base 20 to a work table 105 conveniently located near the work activity. FIG. 3A shows the tool rack 5 releasably and slidingly attached to the base 20 by the interlocking rail mechanism 120 comprised of rack rail 55 and base rail 60. A base transporting wheel braking mechanism 115 of the base transporting wheels 35 is disengaged allowing a rolling motion of the transporting wheels 35 to roll the tool rack 5 and base 20 to the work table 105 where the base transporting wheel braking mechanism 115 of the base 20 is engaged to lock the base 20 in position. FIG. 3B shows the rail lock 65 of the rack rail 55 and base rail 60 disengaged and the tool rack 5 rolled onto a work surface 75 of a work table via tool rack wheels 70. In this configuration the tool rack 5 and rack rail 55 are disconnected from the base 20 and base rail 60 and a tool rack braking mechanism 110 of the tool rack 5 is engaged to prevent rolling of the base transporting wheels 125 on the work table 105. The exemplary embodiment is stationary and secure for utilization.

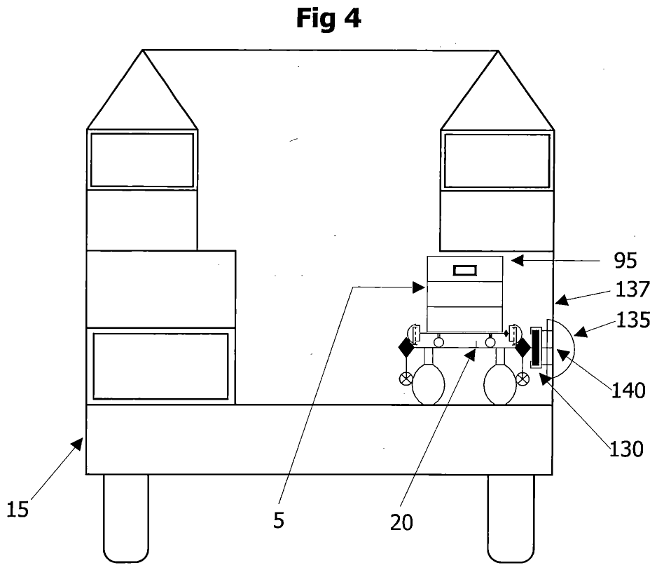

FIG. 4 shows the tool rack 5 attached to the base 20 in collapsed configuration 25 on a flat surface 90 of a cargo vehicle 15. The base 20 is releasably attached via slide extension locking mechanism 135 to a slide extension mechanism 140 that is permanently attached to a side wall 137 of a motorized vehicle 15. The tool rack 5 and base 20 is positioned in a motorized vehicle for transport to a warehouse or work site.

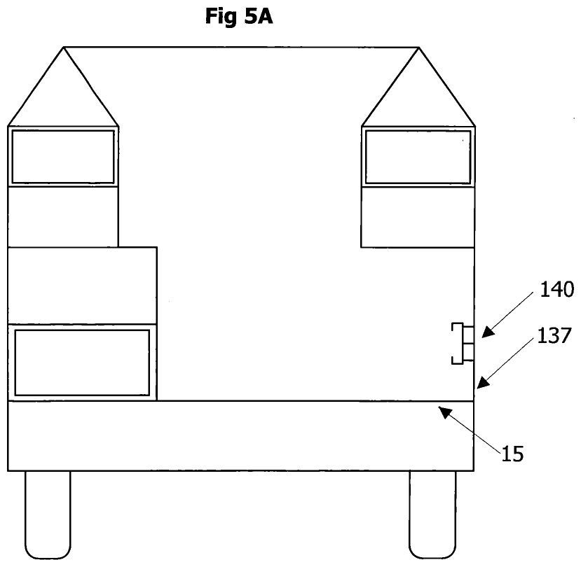

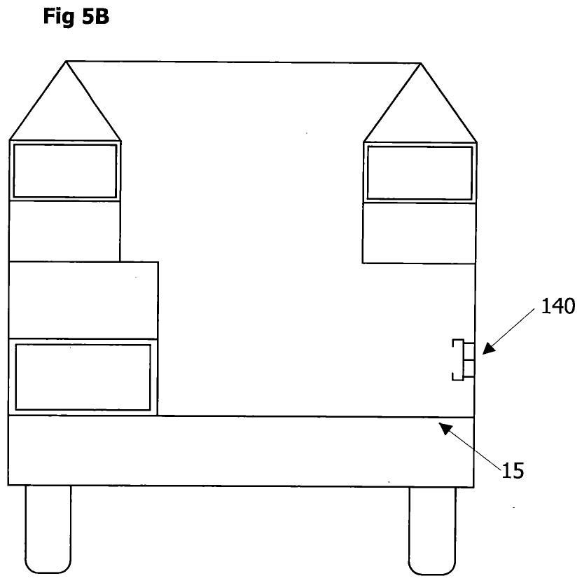

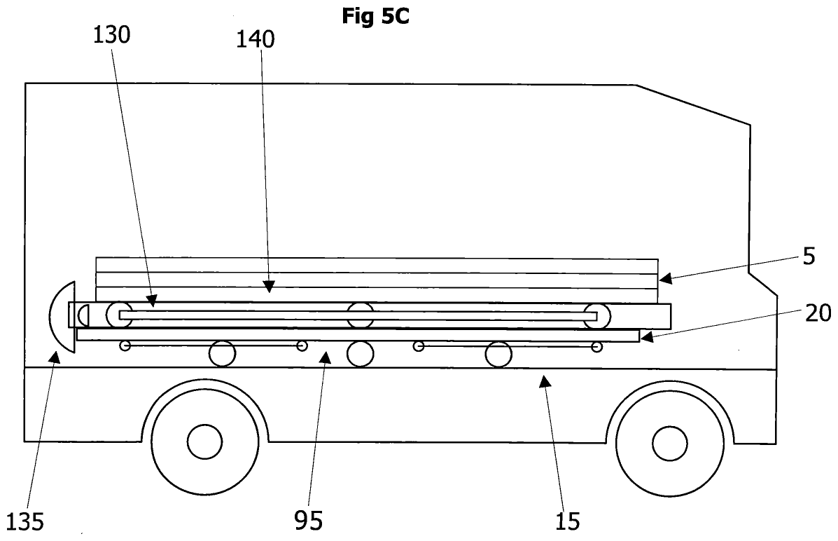

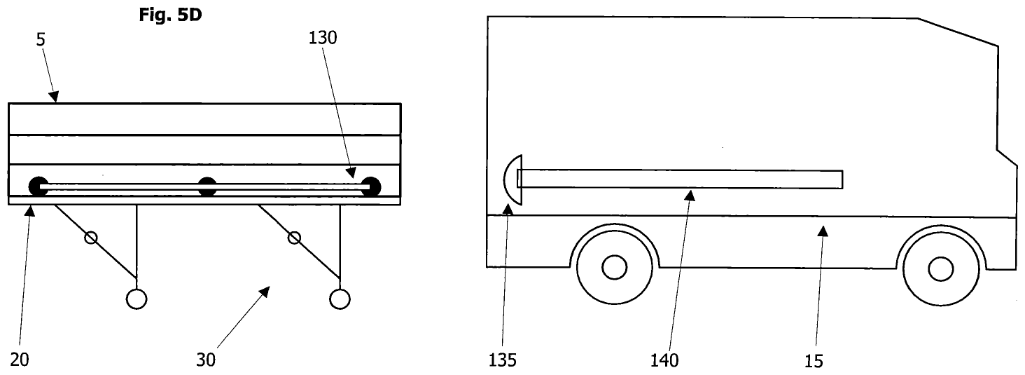

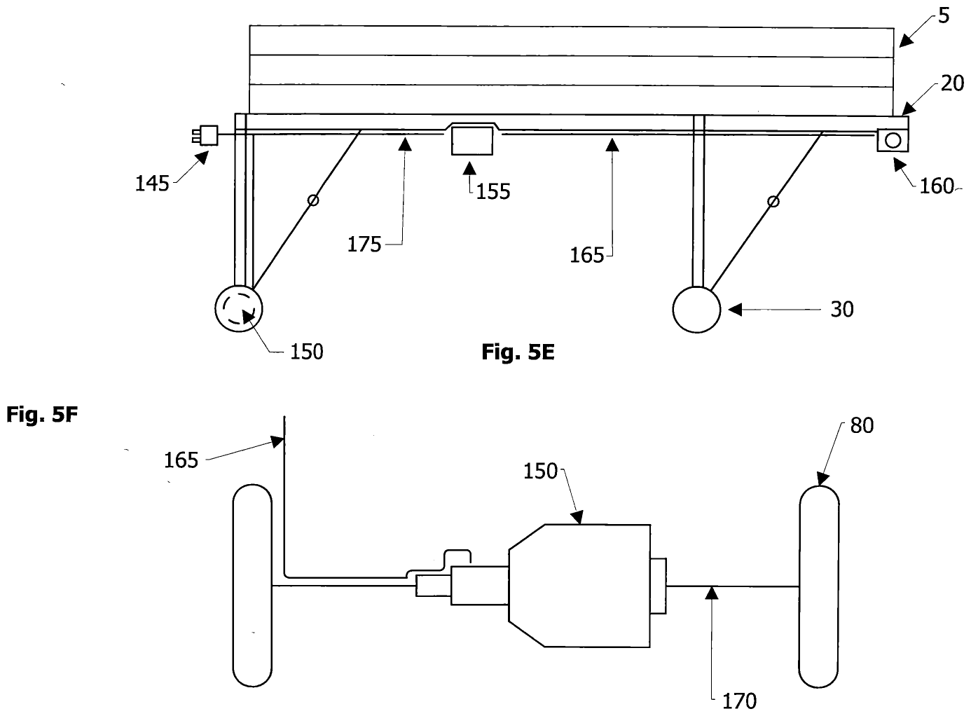

FIG. 5A shows the rearward view of a flat delivery surface 15 of a motorized vehicle and the slide extension mechanism 140.

FIG. 5B shows the base slide rail 130 slidingly inserted and releasably attached to the slide extension mechanism 140 on a side wall 137 of a motorized vehicle 15 with the collapsible legs 40 of base 20 collapsed in delivery configuration 95 and releasably attached via slide extension locking mechanism 135.

FIG. 5C shows base 20 and base slide rail 130 detached from slide extension mechanism 140 and outside of a motorized vehicle in transporting configuration 30.

FIG. 5D shows base 20 in transporting configuration 30 with the electrical charging plug 145 of an electric motor 150 and rechargeable battery 155 unplugged from a power source. The electric motor 150 can be used to drive the delivery wheels 80. The electric motor 150 is connected to a variable speed controller 160 with a variable speed controller cable 165 which is powered by the rechargeable battery 155.

FIG. 5E shows planar view of a delivery wheel axle 170 of a set of delivery wheels 80 attached to an electric motor 150 and contected to a variable speed controller 160 with a variable speed controller cable 165.

In an alternate embodiment, the flat transportation surface 15 can be located in a van, for example, as shown in FIGS. 5A-D. A metal slide extension mechanism 140 can be permanently attached to the side of the flat transportation surface 15. The slide extension mechanism 140 allows the base 20 to be extended via base slide rail 130 several feet (range 4-8 ft) to the rear of the van or motorized vehicle or retracted back onto the flat transportation surface 15. The slide extension mechanism 140 can have slide wheels, for example, located along the side of the slide extension mechanism 140 to allow the tool rack 5 and base 20 (or only the rool rack 5) to be easily moved from the transportation surface 15 to a location rearward of the motorized vehicle or van.

In one embodiment the tool rack 5 and base 20 can be rolled up to the slide extension mechanism 140 from the work site and the base 20 can be locked to the slide extension mechanism 140 via base slide rail 130. The tool rack 5 and base 20 can then be slid onto the transportation surface 15 using the delivery wheels as described in an earlier embodiment and releasably attached with the base slide rail 130 sliding into the slide extension mechanism 140 and locked into a deliverable position within the motorized vehicle with the slide extension locking mechanism 135. The slide extension mechanism 140 can similarly allow the tool rack 5 and base 20 to be slid off of the transportation surface 15 to the rearward end of the van, for example. The transporting wheels 35 of the base 20 can then be used to deliver the tool rack 5 to a location nearer to the work site.

In another embodiment, the tool rack 5 alone can attached to the slide extension mechanism 140 and slid using the slide wheels to the rear of the transportation surface 15 where the worker is able to better access the tools found in the tool rack 5. The tool rack 5 can be slid off of the transportation surface 15 using the delivery wheels 80. The slide extension mechanism 140 can similarly allow the tool rack 5 and base 20 to be slid back onto the transportation surface 15 from the rearward end of the van, for example. The worker is able to more easily secure a tool from this location that is rearward of the motorized vehicle or van. The tool rack 5 can be a modular tool rack as currently used in the industry.

In an alternate embodiment, the base 20 can have an electric motor 150 assembled in conjunction with the delivery wheel axle 170. This can be connected to a rechargeable battery 155 with a battery charging cable 175 and controlled by a variable speed controller 160 with a variable speed controller cable 170.

1. A device for transporting tools and equipment from a motorized vehicle having a flat transportation surface above the ground to a work site located at a remote distance from said motorized vehicle, said device comprising;
A. a base having two or more transporting wheels attached to a folding frame located at the bottom of said base, said two or more transporting wheels providing ease of rolling said device from said motorized vehicle to said work site in a transporting configuration, said base having base rails permanently attached at or near the top of said base,
B. a tool rack to contain said tools and equipment, said tool rack having tool rack rails permanently attached at or near the bottom of said tool rack, said tool rack being slidingly and releasably attached to said base via a rail interlocking mechanism located at the bottom of said tool rack, said rail interlocking mechanism having a rail lock adapted to lock said tool rack rail with said base rail, said rail lock preventing movement of said tool rack relative to said base in said transporting configuration while providing free access to the tools and equipment within said tool rack,
C. said folding frame configured to allow said base and tool rack to be transferred from said transporting configuration to a delivery configuration located on said flat transportation surface without altering the height above the ground of said base and containment unit,
D. said base further comprising two or more delivery wheels attached to said base, said delivery wheels configured to allow said device to roll onto said flat transportation surface in said delivery configuration.

2. The device of claim 1 wherein said rail lock is a removable pin or other mechanical mechanism.

3. The device of claim 1 wherein said tool rack comprises one or more sliding shelves.

4. The device of claim 3 wherein said one or more sliding shelves have free sliding movement as said tool rack is attached to said base.

5. The device of claim 4 wherein said one or more sliding shelves are replaceable with other of said shelves containing other of the tools and equipment.

6. The device of claim 1 wherein said tool rack rails and said base rails are interlockingly attached to prevent lateral movement relative to each other and provide sliding movement.

7. The device of claim 1 wherein said two or more transporting wheels are motorized wheels.

8. The device of claim 1 wherein at least two of said delivery wheels are in contact with said flat transportation surface while at least two of said transporting wheels are in contact with the ground.

9. A device for transporting tools and equipment from a motorized vehicle having a flat transportation surface above the ground to a work site located at a remote distance from said motorized vehicle, said device comprising;
A. a base having a folding frame, said base having two or more transporting wheels providing ease of rolling said device from said motorized vehicle to said work site in a transporting configuration, said base having base rails attached at or near the top of said base,
B. a tool rack to contain said tools and equipment, said tool rack having tool rack rails located entirely and attached entirely at or near the bottom of said tool rack, said tool rack being slidingly and releasably attached to said base via a rail interlocking mechanism located at the bottom of said tool rack, said rail interlocking mechanism adapted to lock said tool rack rail with said base rail via a rail lock, said rail lock preventing movement of said tool rack relative to said base in said transporting configuration, said rail lock providing free access without restriction to the tools and equipment within said tool rack,
C. said folding frame configured to allow said base and tool rack to be transferred from said transporting configuration to a delivery configuration located on said flat transportation surface without altering the height above the ground of said base and containment unit.

10. A device for transporting tools and equipment from a flat surface above the ground to a work site located at a remote distance from said flat surface, said device comprising;
A. a base having two or more transporting wheels attached to a folding frame located at the bottom of said base, said two or more transporting wheels providing ease of rolling said device from said flat surface to said work site in a transporting configuration, said base having base rails located at or near the top of said base,
B. a tool rack to contain said tools and equipment, said tool rack having tool rack rails located at or near the bottom of said tool rack, said tool rack being slidingly and releasably attached to said base via an interlocking rail mechanism located at the bottom of said tool rack, said interlocking rail mechanism preventing lateral movement of said tool rack relative to said base in said transporting configuration, said interlocking rail mechanism providing full access without restriction to the tools and equipment within said tool rack when said tool rack is attached to said base,
C. said folding frame configured to allow said base and tool rack to be transferred from said transporting configuration to a delivery configuration located on the flat surface.

11. The device of claim 10 wherein said interlocking rail mechanism includes a rail lock to prevent movement between said tool rack and said base.
